(19) United States
(12) Patent Application Publication
(10) Pub. No.: US 2007/0157803 A1
(43) Pub. Date: Jul. 12, 2007

(54) Nitrogen inerting system

(75) Inventors: John McNeil, Kent (GB); Andrew Van Den Gross, Kent (GB); Arthur Lyons, Kent (GB)

Correspondence Address: MCCORMICK, PAULDING & HUBER LLP, CITY PLACE II, 185 ASYLUM STREET, HARTFORD, CT, 06103, US

(73) Assignee: Smart-Membrane Corp., Nassau (BS)

(21) Appl. No.: 10/584,878

(22) PCT Filed: Dec. 23, 2004
(86) PCT No.: PCT/GB04/05415

§ 371 Date: Aug. 29, 2006

(30) Foreign Application Priority Data
Dec. 31, 2003 (GB) 0330257.7

(51) Int. Cl. B01D 53/22

(52) U.S. Cl. 95/45; 96/10

(57) ABSTRACT

A gas separation module 25 is disclosed for separating air into nitrogen 27 and oxygen 26 enriched fractions. The nitrogen enriched fraction 27 may be used to inert an atmosphere inside a fuel tank 32. The air is separated into nitrogen 27 and oxygen 26 enriched fractions by providing a plurality of strands of gas separation membrane wound around a core and maintaining a pressure difference across the walls of the strands of membrane. A low pressure difference of≦30 psi maintained across the membrane is able to effect gas separation and provide highly nitrogen enriched air. The membrane has preferably been subjected to a modification technique to increase its gas permeability.

The present invention relates to an energy efficient gas separation system that can separate atmospheric air into a highly enriched nitrogen fraction and slightly enriched oxygen fraction. The nitrogen rich air from the gas separation system contains enough nitrogen to enable the air to be used as an inert atmosphere inside tanks or vessels containing flammable or volatile materials, such as fuels, solvents and chemicals, to reduce the risk of fire and explosion.

A composite hollow fibre membrane is used as the gas separation medium. The membrane may consist of a polyethersulfone fibre tube coated on the outside with a very thin layer of selective polymer preferably comprising polydimethylsiloxane, more preferably cross-linked and non cross-linked polydimethylsiloxane. A preferred feature of the hollow fibre membrane is that the fibre tube is subjected to a special modification technique that significantly increases the gas permeability properties of the fibre before it is coated with the selective outer layer.

The gas separation membrane is described in detail in GB 2397303. The modification technique involves the application of liquids to the outside wall of the fibre tube, which changes the structure of the pores and the polymer supports located near the outer surface of the fibre tube. The modification technique increases the number of pores in the fibre tube and also improves the relative distribution of exposed open pores and polymer supports in the outer surface of the fibre tube. The modification technique involves soaking the outer surface of the fibre tube with a solution of acetone, displacing the acetone solution with distilled water and then quickly drying the fibre tube, e.g. a drying time of 60 seconds. The water drying quickly from the pores of the fibre, has the effect of pulling on the polymer substructures causing them to rupture, resulting in the formation of new pores and new substructures. Relatively rapid drying of the tube is achieved by applying a vacuum or pressure differential to the fibre tube. Repeated cycles of soaking and drying results in a fibre tube with preferably up to twice as many pores in its structure as unmodified fibre.

The modification process also changes the surface characteristics of the fibre tube so that the outer surface of the fibre tube is able to support a very thin (e.g. 0.1 to 1.0 micron thick), uniform, defect free layer of the selective polydimethylsiloxane polymer. This combination of a very porous fibre tube and a very thin selective coating results in a composite hollow fibre membrane that has relatively high gas permeability and a reasonable degree of gas selectivity. The modified composite hollow fibre membrane may also be plasma treated to further improve the gas selectivity properties of the membrane.

Other polymers are also used to produce hollow fibre tubes that are capable of supporting a coating of polydimethylsiloxane polymer, including, for example, polyamideimide and cellulose acetate materials. It may well be that the fibre modification technique, or an adaptation of the technique, could be applied to fibre tubes manufactured from these alternative polymer materials before the tubes are eventually coated with polydimethylsiloxane.

Because the modified hollow fibre membrane has high permeability properties, the membrane is able to separate normal atmospheric air into nitrogen and oxygen rich fractions by the application of a relatively low differential pressure between the outside of the membrane and the hollow core of the membrane. For example, a light vacuum of about 0.5 bar applied to the hollow core of the membrane is sufficient to draw atmospheric air through the wall of the membrane and allow the membrane to selectively enrich the air with oxygen. The permeate oxygen rich air accumulates in the hollow core of the membrane, whilst the retentate nitrogen rich air remains on the outside of the membrane.

Because the gas separation system operates under low pressure, the separation process is energy efficient and the gas separation module that contains the hollow fibre membrane can also be of a lightweight construction.

Incorporating a blanket of inert nitrogen rich air above a volatile or flammable liquid stored in a tank is an effective method of reducing the risk of flammable vapour in the headspace of the tank being accidentally ignited. To inhibit ignition and combustion, the inert atmosphere above the flammable liquid needs to contain less than 13% oxygen, and preferably the inert atmosphere should contain between 10% and 12% oxygen, i.e. an air composition of between 10% oxygen, 90% nitrogen and 12% oxygen, 88% nitrogen. If the nitrogen rich air contains less than 10% oxygen it would provide an extremely inert atmosphere.

A cost effective nitrogen inserting system could have various end use applications, including the inserting of fuel tanks on board aircraft, fuel tanks on board marine vessels, fuel tanks inside transport vehicles and large storage tanks used to contain bulk volumes of flammable or volatile materials. For example, fires and explosions inside aircraft fuel tanks are usually caused by an electrical source inside a fuel tank producing a spark that ignites the mixture of fuel vapour and air which has built up in the headspace of the tank. During refuelling, a static charge in the filling nozzle of the fuel tank can also ignite vapour that has been released from the aviation fuel. Although rare, the consequences of a fire or explosion in an aircraft fuel tank are invariably catastrophic.

Improvements in the safety of aircraft fuel tanks have tended to concentrate on minimising the ignition sources that can come into contact with the fuel vapour in the headspace of the fuel tank. However, aviation safety authorities have recently recognised that incorporating an inert atmosphere in the headspace of aircraft fuel tanks would also significantly reduce the risk of fire and explosion.

Fuel tanks and other storage tanks on board ships, warships and oil/gas platforms also provide a potential risk of fire and explosion, and again a nitrogen inserting system would provide a cost effective means of reducing this risk.

With regard to transport vehicles, static charges generated in the filling neck of a fuel tank during refuelling can ignite the vapour released from the more volatile conventional petroleum fuels, for example, such as petrol.

However, the flame is unable to propagate down the fill pipe into the fuel tank because the mixture of petrol vapour and air in the pipe is too rich, i.e. there is not enough oxygen in the mixture to support combustion. Consequently the risk of fuel tank fires and explosions with conventional transport fuels is extremely low.

Alternative transport fuels are being developed as substitutes for conventional fuels, and some of these are more volatile and flammable than their petroleum counterparts. There is therefore an increased risk that whilst filling the fuel tank with these particular fuels, the mixture of fuel vapour and air in the neck of the tank may accidentally ignite under normal temperature conditions.

For example, E-Diesel, a blend of 15% natural ethanol and 85% diesel, has been developed as an alternative fuel for commercial transport vehicles. Because the natural ethanol constituent is manufactured from renewable energy resources, E-Diesel has significant environmental benefits. Ethanol and diesel are immiscible and blending agents are used to form a mixture of the two materials.

The ethanol and the diesel in the blended fuel retain their individual vapour pressures, and at normal ambient temperatures the headspace in the fuel tank is therefore mainly filled with the more volatile ethanol vapour. Unfortunately, the low flash point and greater flammability of the ethanol vapour increases the risk that during refuelling a static charge could ignite the ethanol vapour present in the neck of the tank. Because of the stoichiometric concentration of the ethanol vapour under normal temperature conditions, the flame could then potentially travel down into the fuel tank and cause a catastrophic failure.

GB 2397821 describes a method of using the aforementioned hollow fibre membrane to produce nitrogen rich air on board aircraft for use as an inert atmosphere inside the fuel tanks of the aircraft. The gas separation module described in this particular patent application was based on a traditional design of module, where a very large number of individual membranes are cut to an appropriate size and they are then densely packed, in a substantially parallel manner, into the module. The individual membranes are potted into polymer potting compound in the module, not only to hold the membranes in place inside the module but also to slightly separate the membranes from each other so that air can circulate around the outside of the membranes. This type of gas separation module is therefore bulky and the large amount of potting compound required to hold the membranes in place adds to the weight of the module.

The present invention seeks to provide an improved gas separation module that uses the unique low pressure properties of the permeable hollow fibre membrane in a manner whereby the module can be of a much more compact, as well as lightweight, construction. A compact and lightweight energy efficient nitrogen inserting system would be particularly advantageous for transport applications, such as on board aircraft and inside vehicles, where weight and space are especially important.

One way of achieving a more compact membrane arrangement would be to wind lengths of hollow fibre membrane in a substantially spiral manner around a hollow tube located inside the gas separation module, instead of aligning separated straight strands of membrane in a parallel fashion along the length of a module. Spirally wound hollow fibre gas separation devices are well known in the art; however, such devices invariably have to operate under high pressures to obtain effective separation, and the in-feed air is usually pressurised to at least 50 psi and could even be as high as 100 psi.

From a first broad aspect, therefore, the present invention provides a low pressure method of gas separation that comprises a plurality of strands of hollow fibre membrane arranged in a substantially spiral, entwined manner inside a lightweight gas separation module.

In a preferred embodiment the present invention provides an energy efficient gas separation system wherein a very long length of the permeable composite hollow fibre membrane is wound around a hollow support tube in a manner whereby the wound layers are closely packed together and are in direct contact with one another. The membrane is preferably wound spirally around a hollow support tube that is preferably manufactured from a lightweight metal or other lightweight material. The enmeshed and layered membrane structure can then be cut at each end to form a bundle of closely entwined stands of membrane that can then be potted into a compact and lightweight gas separation module.

The hollow fibre membrane would typically be at least 1 km in length and more probably the membrane would be at least 1.5 km in length. It is important that the relatively long length of membrane is wound around the metal tube in a carefully controlled manner so as to avoid compression or constriction that could subsequently disrupt the flow of air through the hollow core of the membrane. When the wound membrane is cut, a compact bundle of a very large number of closely intertwined individual membranes is formed. For example, there could be hundreds or even thousands of individual strands of membrane depending on the original length of membrane that was wound onto the tube.

A light vacuum applied to the hollow cores of the intertwined membranes draws air through the wall of the membranes and the air is selectively enriched with oxygen. The retentate air remaining on the outside of the membranes becomes increasingly enriched with nitrogen as the retentate air slowly passes over the outside of the closely intertwined membranes located inside the gas separation module.

The oxygen rich air may be drawn from the hollow cores of the membranes by the permeate vacuum pump. The retentate nitrogen rich air is drawn from the hollow core of the metal tube situated at the centre of the intertwined strands of membrane by either a very light vacuum or other light means of air displacement. The flow rate of the permeate oxygen rich air from the membrane is preferably much higher than the flow rate of the retentate nitrogen rich air. By way of example, a nitrogen inserting gas separation module for use in transport vehicles may produce typical flow rates of about 30 litres/minute and 2 litres/minute for the permeate and retentate air streams respectively.

The different flow rates of the permeate and retentate air streams also have an effect on the composition of the oxygen and nitrogen rich air fractions. For example, the permeate air from the gas separation module is generally only slightly enriched with oxygen and would typically contain about 22% oxygen, i.e. have a composition of 22% oxygen and 78% nitrogen. In contrast, the retentate air gradually becomes highly enriched with nitrogen as it passes over the membranes and would typically contain about 10% oxygen, i.e. a composition of 10% oxygen and 90% nitrogen, or even less, by the time the retentate air leaves the gas separation module. In various embodiments the purity, i.e. composition, and the rate of production of nitrogen enriched air is varied by changing the flow rate of the nitrogen and/or oxygen enriched air out of the gas separation module, and/or by changing the pressure at which air is allowed to enter the gas separation module. The purity and/or rate of production of oxygen enriched air can be varied in a corresponding manner.

Various embodiments of the gas separation module for the nitrogen inserting system will now be described, by way of example only, and with reference to the accompanying drawings in which:

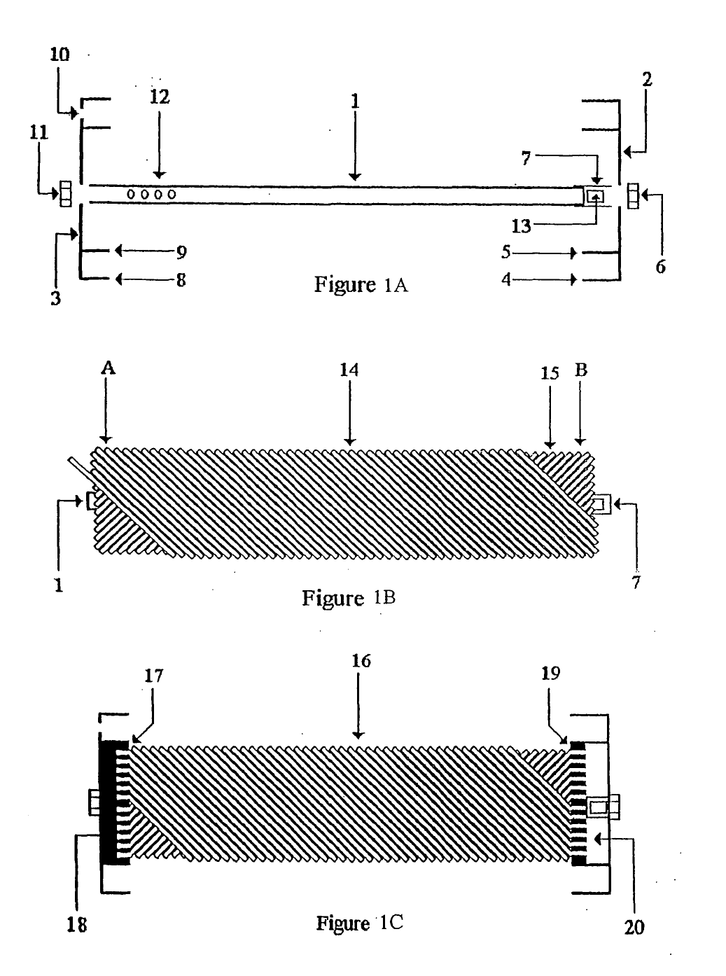

FIG. 1A is a schematic cross-sectional illustration showing the main components used in the construction of the preferred gas separation module, FIG. 1B shows the hollow fibre membrane after it has been completely wound around the hollow metal tube of the gas separation module and FIG. 1C shows the membranes after they have been cut, potted and fixed into place inside the gas separation module.

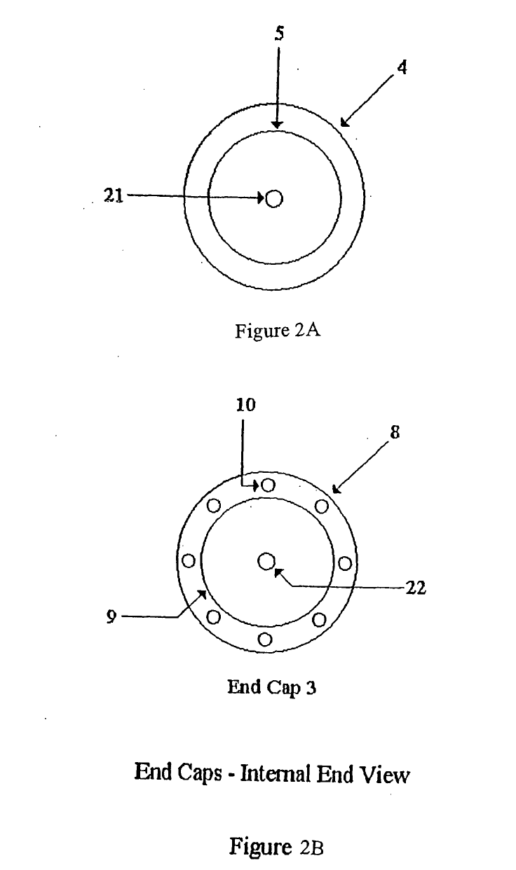

FIGS. 2A and 2B illustrate internal end views of two types of end caps that could be used in the construction of the preferred embodiment.

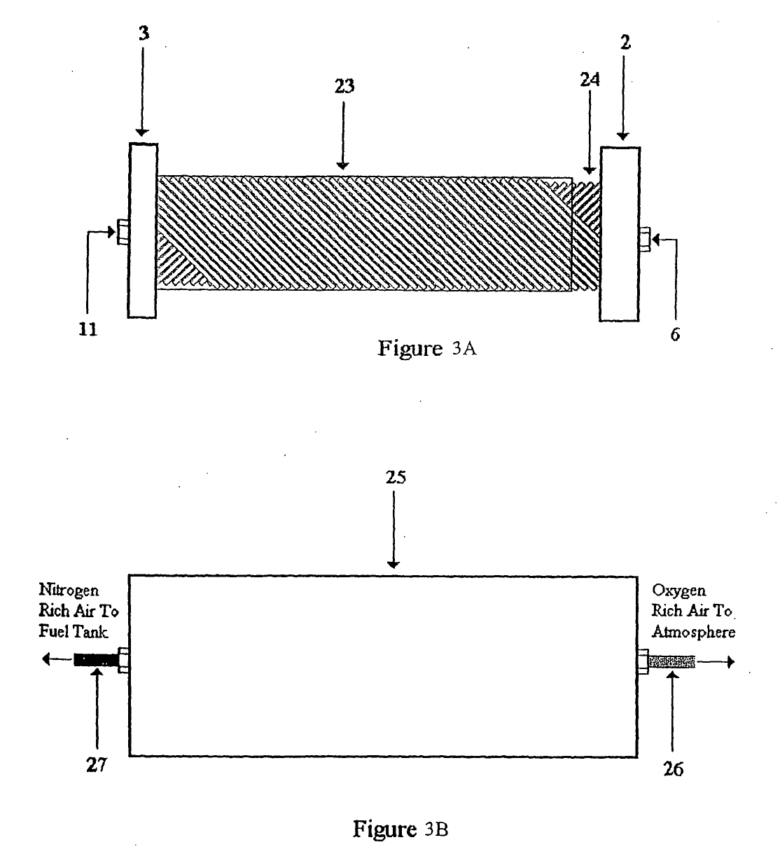

FIG. 3A is a side view showing the potted membranes partly covered by protective film. FIG. 3B is a side view showing the completed gas separation module fitted with one example of an external protective cover.

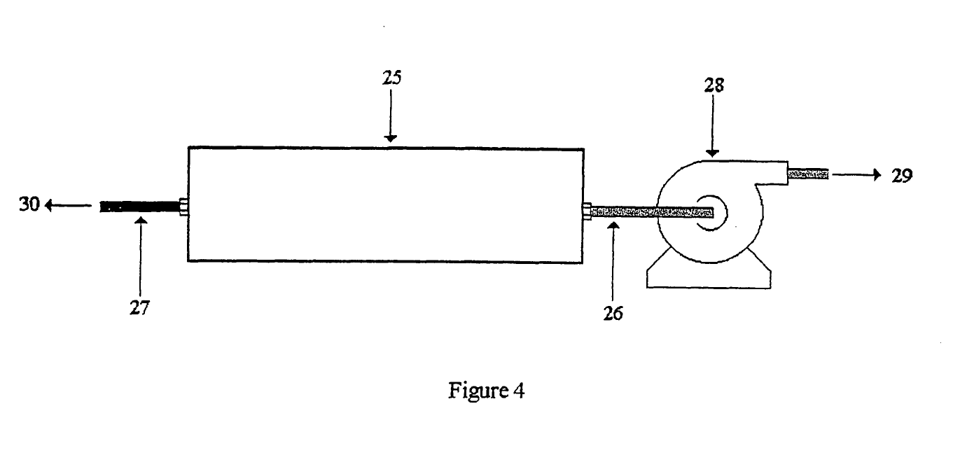

FIG. 4 is a schematic illustration of the gas separation module connected to a vacuum pump.

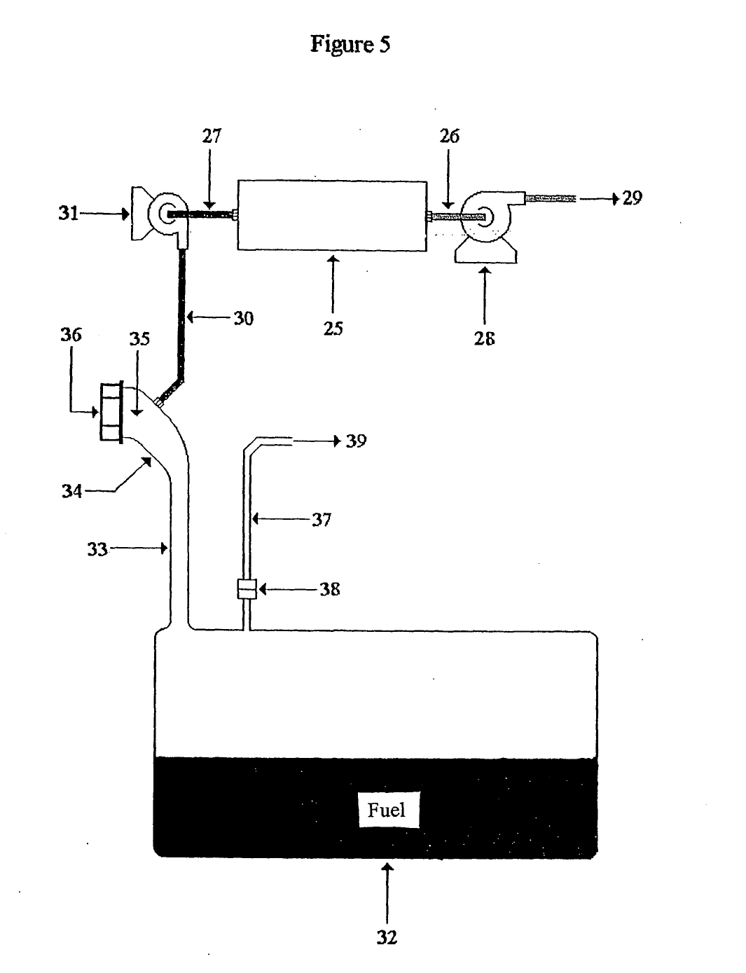

FIG. 5 is a schematic illustration of the preferred embodiment connected to a commercial fuel tank.

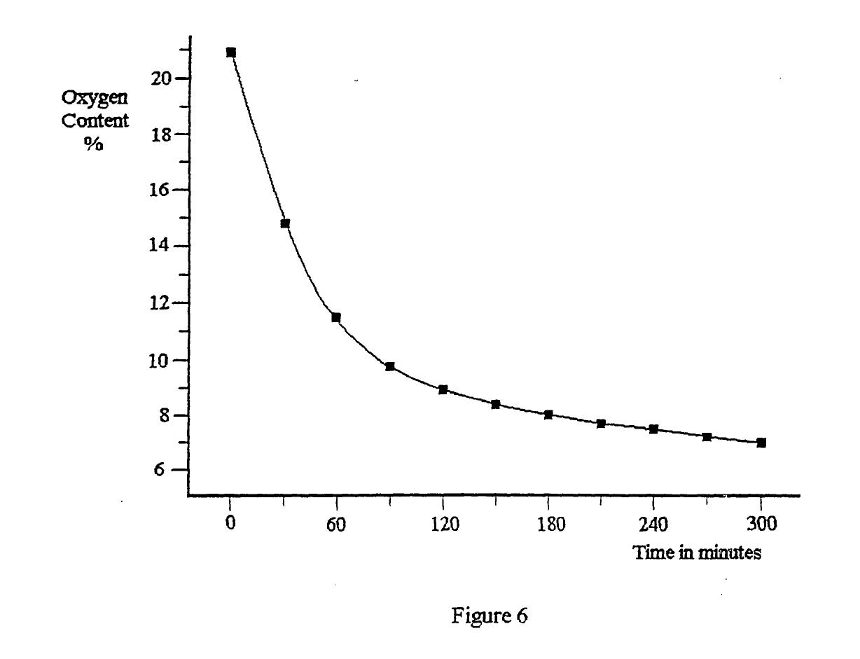

FIG. 6 shows a graph of the oxygen content in the headspace of a fuel tank which is connected to the preferred embodiment against time.

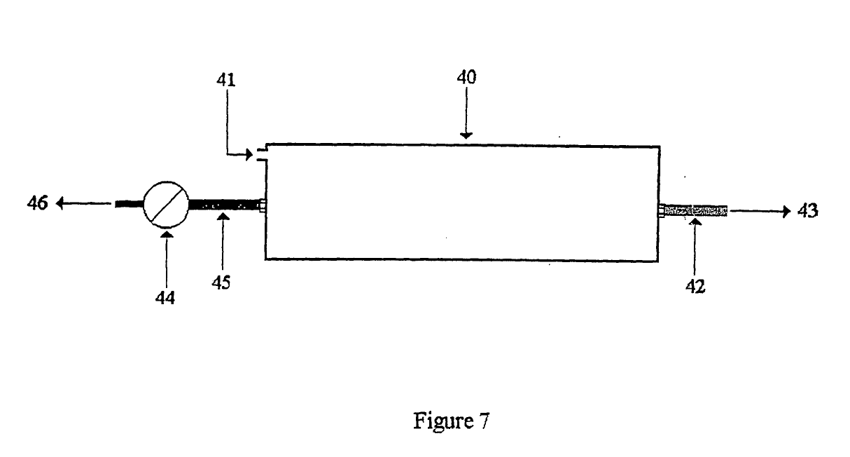

FIG. 7 is a schematic illustration of a preferred embodiment suitable for use in an aircraft flying at cruising altitude.

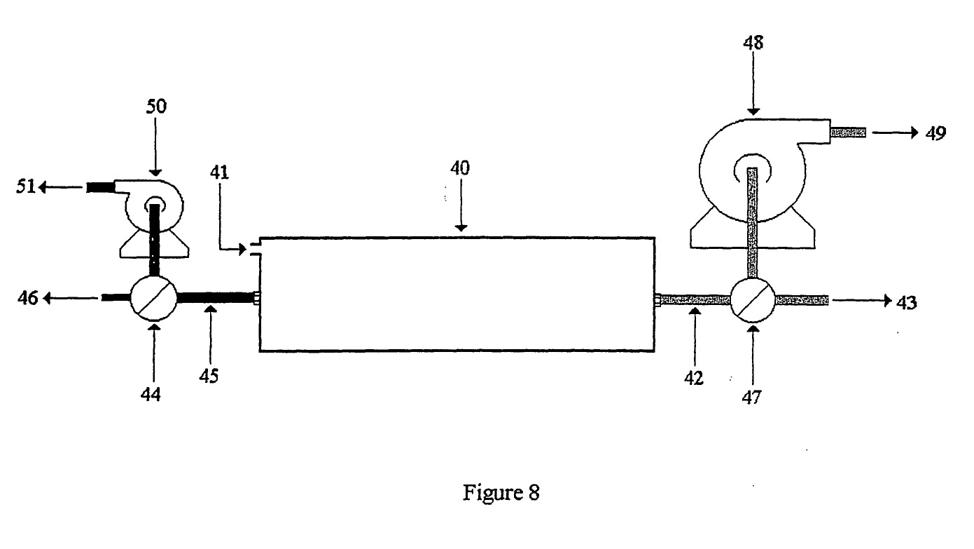

FIG. 8 is a schematic illustration of a preferred embodiment suitable for use in an aircraft flying at various altitudes.

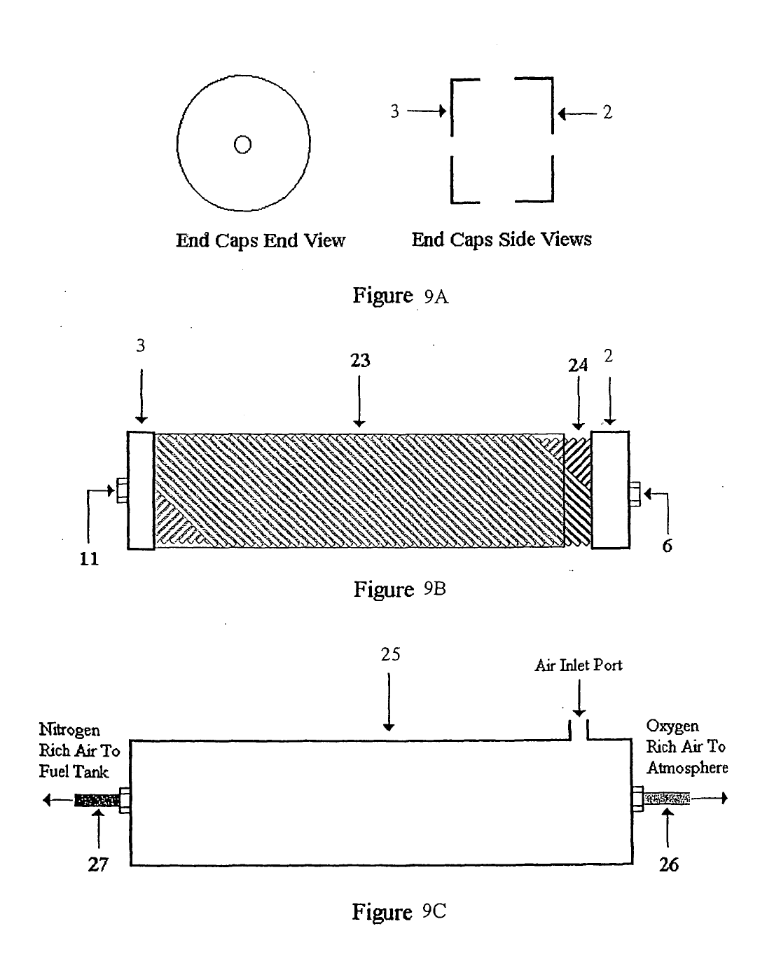

FIG. 9A illustrates end and side views of the end caps used in the construction of another preferred embodiment.

FIG. 9B is a side view of an embodiment showing the potted membrane partly covered by an impermeable film.

FIG. 9C is a side view showing the completed gas separation module fitted with a preferred external protective cover.

With reference to FIGS. 1 and 2, the main components of the gas separation module are a hollow metal tube 1, preferably made from a rigid and lightweight material, more preferably from a lightweight metal such as aluminium or aluminium alloy, and two metal end caps 2 and 3, which may also be made from lightweight metal or some other rigid lightweight material. The metal tube 1 has a series of perforations 12 through the wall of the tube that allow air to pass through the wall of the metal tube into the hollow core of the tube. The perforations 12 may be situated near the end of tube 1 that will eventually be fixed to end cap 3 by means of locking nut 11, and this end of tube 1 is left open.

The opposite end of the metal tube 1 is fixed to a hollow metal fitment 7, which blocks off this end of tube 1. The fitment 7 has openings 13 that allow air to pass through the fitment 7. The free end of fitment 7 is left open and fitment 7 will eventually be fixed to end cap 2 by means of locking nut 6.

As shown in FIG. 2A, end cap 2 may have a circular outer wall 4 and a circular inner wall 5 so that a recess is formed between the outer wall 4 and the inner wall 5. This recess could incorporate a series of holes to allow air to enter the gas separation module, similar to those illustrated on end cap 3 in FIG. 2B. The enclosed space between the inner wall 5 of the end cap 2 and the outside of tube 1 forms a small reservoir for the polymer potting compound that will eventually secure the open ends of the cut hollow fibre membranes in place inside the gas separation module.

In the preferred embodiment a circular hole 21 is provided at the centre of the base of cap 2, which allows the end of fitment 7 to protrude through cap 2 so that it can be locked in place by locking nut 6.

As shown in FIG. 2B, end cap 3 may have a circular outer wall 8 and a circular inner wall 9 so that a recess is formed between the outer wall 8 and the inner wall 9. The recess is preferably perforated with a series of holes 10, which eventually allow atmospheric air to pass through end cap 3 into the gas separation module. The enclosed space between the inner wall 9 of cap 3 and the outside of tube 1 forms a small reservoir for the polymer potting compound that will eventually hold the closed ends of the hollow fibre membranes in place inside the gas separation module.

There is a circular hole 22 at the centre of the base of cap 3, which allows the end of tube 1 to protrude through cap 3 so that it can be locked in place by locking nut 11.

A long length of membrane, i.e. a length of 1 km or more of membrane, is then wound around tube 1 in a carefully controlled manner. The first layer of membrane is wound spirally around tube 1 at an inclined angle, for example, of about 45°, with the membrane inclined from right to left. After the first layer has been wound onto tube 1, the second layer is wound over the first layer at an angle of, for example, 45°, but with the membrane then inclined from left to right. The direction of the incline is then reversed on each subsequent layer until eventually the whole membrane has been wound onto tube 1 in a large number of reversed layers. For example, there could be hundreds or even thousands of layers of membrane wound around tube 1, preferably in a criss-cross fashion, depending on the original length of membrane.

This is illustrated schematically in FIG. 1B, which shows the complete membrane wound onto tube 1. The membranes of layers 14 are inclined at an angle from right to left, whilst the membranes of the lower layers 15 are inclined from left to right. The left hand end of the wound bundle of membranes is then completely cut through along a line marked from A on FIG. 1B. This exposes the open ends of the individual strands of membrane that have been formed from the large number of separate layers of membrane wound around tube 1.

As shown in FIG. 1C, the exposed ends of the membranes are then potted into reservoir 17 in end cap 3 by potting compound 18, so that the ends are completely sealed and airtight, and tube 1 is fixed to end cap 3 by locking nut 11. The potting compound also helps to seal tube 1 to end cap 3. The right hand end of the wound bundle of membranes is then completely cut through along a line marked from B on FIG. 1B. This exposes the opposite open ends of the strands of individual membrane that have been wound onto tube 1. As shown in FIG. 1C, the exposed ends of the membranes are then potted into reservoir 19 in end cap 2 by potting compound in a manner whereby the ends of the membranes are open and lead to an evacuation chamber 20 formed inside cap 2. The end of fitment 7 is fixed to end cap 2 by locking nut 6, and the potting compound also helps to seal fitment 7 in place in cap 2. In fact, to facilitate manufacture, the membranes may be potted into the potting compound first and the potted end then cut through to expose the fibre ends.

The method of manufacture described in relation to FIGS. 1B and 1C results in a structure with a very large number of densely packed and intertwined membranes that can effect gas separation, i.e. structure 16 in FIG. 1C, which in turn allows the gas separation module containing the membranes to be of a very compact construction.

With reference to FIG. 3A, the entwined membranes 16 (shown in FIG. 1C) may be wrapped in a thin plastic film 23, except for a small portion of the membranes 24 adjacent to end cap 2 which would be left exposed to the air entering the module. The plastic film may be preferably of a polymer type that may be permeable to air at high pressures but impermeable to air at the low pressures (e.g. ≦30 psi) prevailing inside the gas separation module. Alternatively, the plastic film could cover the whole length of the entwined membranes 16, and the film would be suitably perforated so as to allow air to pass through the film at a flow rate that would be appropriate to the relative position in the bundle of membranes. For example, there would be very few perforations in the film near end cap 3 so that the flow of air into the bundle of membranes close to end cap 3 was restricted. The number of perforations would then gradually increase across the width of the film, which could allow the flow of air through the film and into the bundle of membranes to correspondingly increase until the highest flow rate was achieved adjacent to end cap 2.

As seen in FIG. 3B, rigid cylindrical protective outer cover 25, manufactured from either lightweight metal or a lightweight material, such as a composite or a plastic material, may then be fitted around the outside of end caps 2 and 3. An exit tube 26 is fitted to locking nut 6 to allow removal of the permeate oxygen rich air from the gas separation module, and an exit tube 27 is fitted to locking nut 11 to allow removal of the retentate nitrogen rich air from the gas separation module.

In an alternative-embodiment shown in FIGS. 9A-9C the diameter of end caps 2 and 3 could be reduced by eliminating the outer recesses of the end caps that provide inlet ports to allow air to enter the gas separation module. Wall 5 on cap 2 and wall 9 on cap 3 (see FIGS. 2A and 2B) would then become the external walls of the end caps, and this would result in a much narrower gas separation module. An inlet port or ports to allow air to enter the module could be provided in the protective cover 25 that is fitted to the outside of the module.

Instead of using a single very long length of hollow fibre membrane in the construction of the gas separation module, it is feasible that a number of shorter, albeit still relatively long lengths of membrane, could be used to produce the membrane strands that are used to effect gas separation inside the module. The membrane strands are preferably entwined. For example, instead of using a single hollow fibre membrane 1 km long, it would be feasible to use say four shorter membranes each of 0.25 km in length, or five membranes each of 0.2 km in length, or ten membranes each of 0.1 km in length, or even a combination of different lengths of membrane. The multiple lengths of membrane could be wound simultaneously or consecutively onto the hollow tube 1, preferably in a carefully controlled criss-cross manner, until the requisite length of membrane has been wound onto the tube.

The individual intertwined gas separation membranes would then be formed from the wound bundle by cutting each end of the bundle and the membranes would be potted as described earlier. The gas separation module would then operate in much the same way as a module formed from a single long length of hollow fibre membrane.

The operation of the gas separation module will now be described with further reference to FIGS. 1A, 1B, 2A, 3A and 3B.

A light vacuum of about 0.5 bar applied to tube 26 draws air from the evacuation chamber 20. The vacuum then builds up in the hollow cores of the densely packed, intertwined membranes until eventually the atmospheric air on the outside of the membranes is drawn through the walls of the membranes and the air is selectively enriched with oxygen. The permeate oxygen rich air is released to the outside atmosphere by tube 26.

Atmospheric air may, in one embodiment, enter the gas separation module through the perforated holes 10 in end cap 3. As the vacuum builds up inside the hollow cores of the membranes, the atmospheric air is drawn into the exposed portion of the wound membranes 24, which may be close to end cap 2. The air then percolates under the protective film 23 and the air gradually passes over the outside of substantially all of the intertwined membranes.

As the air slowly washes over the outside of the membranes, it becomes increasingly enriched with nitrogen as permeate oxygen rich air is drawn through the walls of the membranes by the vacuum in the hollow cores of the membranes. Eventually the retentate nitrogen rich air passes through the perforations 12 in metal tube 1 into the hollow core of the tube.

A very light vacuum of say less than 0.1 bar, or some other light means of air displacement, applied to the exit tube 27 draws the retentate nitrogen rich air out of the hollow core of tube 1. This light vacuum also encourages more atmospheric air to enter the gas separation module through the perforations 10 in end cap 3 and wash across the outside of the intertwined membranes.

The retentate air leaving the module through the exit tube 27 is rich enough in nitrogen to be used directly as an inert atmosphere inside fuel tanks. Typically the permeate oxygen rich air leaving the module in tube 26 would consist of 22% oxygen, 78% nitrogen, and the retentate nitrogen rich air leaving the module in tube 27 would consist of about 10% oxygen, 90% nitrogen.

As the hollow fibre membrane used in the gas separation module is able to separate air into oxygen and nitrogen rich fractions by means of a low pressure differential across the wall of the membrane, under certain practical conditions it might well be feasible to augment the negative vacuum pressure on the inside of the membrane with a slight positive pressure on the outside of the membrane. For example, certain road vehicles, such as lorries and buses, have a supply of compressed air available to assist braking, whilst passenger aircraft use compressed air from the aircraft engines to supply fresh pressurised air to the air conditioning system inside the aircraft. Under these circumstances, the pressurised air may be introduced to the outside of the membranes preferably at a slight positive pressure of say 5 to 10 psi relative to the ambient atmospheric pressure (i.e. cabin pressure in an aircraft). A negative vacuum pressure of say 5 to 8 psi relative to the ambient atmospheric pressure could be simultaneously applied to the inside of the membranes. The positive and negative pressures could therefore be arranged so as to produce a differential working pressure across the walls of the membranes that would provide effective air separation.

Providing the pressure of the in-feed air is only slightly above the ambient atmospheric pressure, for example a positive pressure of less than 10 psi relative to the ambient atmospheric pressure, the gas separation module would not need to be highly pressure resistant, although it would have to be air tight, and the module could therefore still be manufactured from lightweight materials. obviously, there would be significant energy savings if a supply of compressed or pressurised air was readily available for the gas separation process. In addition, the inherent positive pressure on the outside of the membranes would naturally displace the retentate air from the module and a retentate vacuum pump would not be required.

The volume and the composition of the retentate nitrogen rich air can be varied in a number of ways including, for example, by altering the gas separation properties of the hollow fibre membrane; by changing the length of hollow fibre membrane packed into the module; and by altering the relative pressures and flow rates of the permeate and retentate air streams.

For example, the vacuum on the permeate oxygen rich air stream could be varied between say 0.4 bar and 0.8 bar, although preferably the permeate vacuum would typically be between 0.4 and 0.6 bar, whilst the vacuum on the retentate nitrogen rich air stream would preferably be no more than 0.1 bar. Alternatively, a lighter vacuum could be used inside the membrane if the air being introduced into the module was lightly pressurised, and in this case the positive pressure on the outside of the membrane could also be varied to change the volume and/or composition of the nitrogen rich retentate air being produced by the gas separation module. The following Table 1 also illustrates how altering the flow rate of the retentate air stream can significantly affect the nitrogen content of the retentate air. The measurements given in Table 1 were obtained from a typical nitrogen inserting module operating in a manner whereby the permeate air stream was maintained at a constant vacuum relative to the atmospheric pressure of the intake air, whilst the flow rate of retentate air was varied by altering the vacuum applied to the retentate air stream.

TABLE 1
Nitrogen Content of the Retentate Air
Under Different Retentate Flow Rates

| Retentate Flow Rate | Composition of the | Permeate Vacuum |
|---|---|---|
| Litres/minute | Retentate Air | Psi |
| 8.0 | 15% oxygen, | −11.2 |
| | 85% nitrogen | |
| 6.0 | 13% oxygen, | −11.2 |
| | 87% nitrogen | |
| 4.0 | 11% oxygen, | −11.2 |
| | 88% nitrogen | |
| 2.0 | 9% oxygen, | −11.2 |
| | 91% nitrogen | |
| 1.0 | 6% oxygen, | −11.2 |
| | 94% nitrogen | |
| 0.5 | 5% oxygen, | −11.2 |
| | 95% nitrogen | |

Being able to readily vary the flow rate and/or the composition of the retentate nitrogen rich air is a particularly important requirement for certain end-use applications. For example, to adequately inert the fuel tanks onboard an aircraft throughout the flight of the aircraft, the nitrogen inserting system needs to be able to produce low flow rate, high purity nitrogen rich air whilst the aircraft is in climb and cruise modes, and high flow rate, low purity nitrogen rich air during the descent of the aircraft.

The volume of nitrogen rich air available for inserting purposes can also, of course, be increased by operating a multiplicity of gas separation modules together in parallel.

Alternative nitrogen inserting systems, based on the principles described above, have been developed for different end-use applications, and some typical examples are described below.

### EXAMPLE 1

The first example is a relatively simple application involving the supply of an inert atmosphere to the fuel tank of a prototype racing sports car fueled by natural ethanol. The flammability and volatility of the ethanol fuel poses a fire risk during refuelling under race conditions, and a nitrogen inserting system was therefore developed for the racing car. The inserting system is described with reference to FIG. 4.

A 1.5 km length of the composite hollow fibre membrane, produced by the method disclosed in GB 2397303, and in the form of a multitude of intertwined strands of membrane, is contained inside the gas separation module 25. Exit tube 26 is connected to a vacuum pump 28 so that the hollow cores of the intertwined membranes can be subjected to a vacuum of about 0.5 bar. The vacuum pump draws permeate oxygen rich air 29 from the gas separation module at a rate of about 30 litres/minute.

In this particular application, under racing conditions the sports car has high fuel consumption and the ethanol fuel is used at an average rate of about 3 litres/minute. The fuel level therefore falls quickly inside the fuel tank and the resulting pressure drop in the tank is sufficient to draw the retentate nitrogen rich air 30 directly from the gas separation module 25 into the fuel tank, without the assistance of an additional air displacement pump. Under these particular operating conditions, the nitrogen rich air 30 from the gas separation module 25 would contain about 11% oxygen, i.e. the inert air would have a typical composition of 11% oxygen, 89% nitrogen. The exit tube 27 containing the nitrogen rich air 30 may be connected directly into the mouth of the fuel tank inside the racing car.

As the fuel level drops, inert nitrogen rich air 30 is automatically sucked from the gas separation module 25 into the fuel tank, whilst the permeate oxygen rich air 29 from the vacuum pump 28 is released into the outside atmosphere.

The inert nitrogen rich air 30 accumulates in the mouth and the filling neck of the fuel tank, and builds up in the headspace of the fuel tank. The inert nitrogen rich atmosphere in the mouth of the tank helps to reduce the risk of a static charge accidentally igniting ethanol vapour during refuelling.

Even if the ethanol vapour in the mouth of the tank did ignite, the inert atmosphere in the filling neck of the fuel tank would prevent the flame propagating down into the fuel tank. An inert atmosphere in the fuel tank is also an additional safety feature in the event of the sports car suffering either an accident or impact damage during racing.

The properties of the nitrogen inserting system developed for the motor racing sports car are summarised in Table 2.

TABLE 2
Nitrogen Inerting System
For a Racing Sports Car Fuelled by Natural Ethanol

| Property | Value |
|---|---|
| Length of hollow fibre membrane | 1.5 km |
| Diameter of the gas separation | 10 cm |
| module | |
| Length of the gas separation | 38 cm |
| module | |
| Volume of the gas separation | 3 liters |
| module | |
| Weight of the gas separation | <1.5 kg |
| module | |
| Sports car fuel consumption | 180 liters/hour |
| Flow of nitrogen rich air into | 3 liters/minute |
| fuel tank | |
| Typical composition of nitrogen | 11% oxygen, 89% |
| rich air | nitrogen |
| Vacuum on permeate air stream | Approx. 0.5 bar |
| Flow of oxygen rich air to | 30 liters/minute |
| atmosphere | |

### EXAMPLE 2

FIG. 5 illustrates a nitrogen inserting system developed for commercial transport vehicles that would be fueled by a volatile fuel such as the E-Diesel blend of ethanol and diesel.

There are significant performance differences between commercial transport vehicles and the motor racing sports car described in Example 1. For example, a typical commercial transport vehicle probably has an average fuel consumption of between 10 and 20 litres/hour, whereas the motor racing car has a fuel consumption of about 180 litres/hour.

With reference to FIG. 5, a vacuum pump 28 draws the oxygen rich air 29 from the gas separation module 25 through exit pipe 26 and the oxygen rich air 29 is released into the atmosphere. The fuel consumption of a normal commercial transport vehicle would be insufficient to create a differential pressure in the fuel tank 32 that would be reliable enough to draw the inert nitrogen rich air 30 from the gas separation module 25 into the tank. A light vacuum pump 31 is therefore used to displace the nitrogen rich air 30 from the gas separation module 25 into the fuel tank 32.

FIG. 5 illustrates a typical commercial fuel tank 32, which has a filling neck 34 leading to a filling pipe 33 connected to the fuel tank 32. The filling neck 34 is sealed by a filling cap 36. The light pump 31 feeds the nitrogen rich air 30 into the mouth 35 of the filling neck 34 and the inert air 30 then gradually percolates down the filling pipe 33 into the headspace of the fuel tank 32.

As the inert nitrogen rich air 30 accumulates in the mouth 35, the filling neck 34, the filling pipe 33 and the headspace of the fuel tank 32, the atmosphere becomes increasingly more inert. It is therefore extremely unlikely that a static charge generated in the mouth 35 of the filling neck 34 during refuelling would be able to ignite any ethanol vapour present in the mouth of the fuel tank. Even if the ethanol vapour did ignite, the inert atmosphere in the filling neck 34 and the filling pipe 33 would inhibit combustion and the flame would not be able to spread down into the fuel tank 32.

The fuel tank may be fitted with a venting pipe 37 that allows any excessive build-up of fuel vapour 39 in the headspace of the tank 32 during relatively warm conditions to be vented either to the outside atmosphere or to the air intake of the engine. The venting process is controlled by a pressure relief valve 38. The pressure of the nitrogen rich air 30 supplied into the fuel tank 32 by pump 31 would not, on its own, be high enough to activate the pressure relief valve 38.

Venting systems vary between different fuel tanks. For example, some tanks vent fuel vapour back into the mouth of the fuel tank, and a pressure relief filling cap is used to allow excessive build-up of vapour to be released into the atmosphere. The nitrogen inserting system described in FIG. 5 should be able to work satisfactorily with any of the normal methods employed to vent fuel tanks.

The nitrogen inserting system was tested under simulated conditions by using a 200 litre fuel tank 32 filled with E-Diesel fuel. Initially, the headspace over the fuel in the tank 32 was filled with normal atmospheric air, i.e. air with a composition of 21% oxygen, 79% nitrogen. The flow of fuel from the tank 32 was set at a constant flow rate of 20 litres/hour, and the flow of nitrogen rich air 30 from the gas separation module 25 into the tank 32 was controlled at 1.5 litres/minute. The oxygen content of the air in the headspace of the fuel tank 32 was measured at regular intervals.

As shown by the graph in FIG. 6, under the above test conditions an inert atmosphere, i.e. air containing less than 13% oxygen, was achieved in the headspace of the fuel tank 32 in less than 40 minutes and after 60 minutes the inert air in the headspace of the tank 32 contained only 11.5% oxygen. The air in the headspace then gradually became increasingly more inert until after 5 hours running, by which time the tank was only half full of fuel, the air was extremely inert and contained only 7% oxygen, i.e. an air composition of 7% oxygen, 93% nitrogen.

At an oxygen concentration of 7%, the very inert atmosphere inside the fuel tank 32 would also help to reduce the risk of fire in the event of either an accident or an impact that damaged or ruptured the fuel tank 32.

Because nitrogen rich air 30 is continually fed into the fuel tank 32 by the nitrogen inserting system whenever the engine of the vehicle is running, an inert atmosphere is always maintained in the filling neck and in the headspace of the fuel tank. When the vehicle is parked and the engine is not running, most fuel tanks are airtight enough to be able to retain the inert atmosphere inside the tank for an appreciable length of time.

The properties of the commercial transport vehicle nitrogen inserting system, as tested in the laboratory, are summarised in Table 3.

TABLE 3
Nitrogen Inerting System
For a Commercial Transport Vehicle Fuelled by E-Diesel

| Property | Value |
|---|---|
| Length of hollow fibre | 1.5 km |
| membrane | |
| Diameter of the gas separation | 10 cm |
| module | |
| Length of the gas separation | 38 cm |
| module | |
| Volume of the gas separation | 3 liters |
| module | |
| Weight of the gas separation | <1.5 kg |
| module | |
| Tested fuel consumption | 20 liters/hour |
| Vacuum on retentate air stream | Less than 0.1 bar |
| Flow of nitrogen rich air | 1.5 liters/minute |
| Composition of nitrogen rich | Down to 7% oxygen, 93% |
| air | nitrogen |
| Vacuum on permeate air stream | Approx. 0.8 bar |
| Flow of oxygen rich air | 30 liters/minute |

A supply of compressed air may also be available from the braking systems used in many commercial transport vehicles, and if the normal atmospheric air being fed into the air separation module was replaced by slightly pressurised air then the vacuum applied to the inside of the membranes could be reduced accordingly. The positive pressure on the outside of the membranes would also displace the retentate air from the module and a retentate vacuum pump would not be required.

### EXAMPLE 3

Large passenger aircraft fly at high altitudes, typically a height of about 11000 metres, in order to conserve fuel and achieve an adequate flight range. Although the atmospheric air composition remains the same irrespective of altitude, i.e. 21% oxygen, 79% nitrogen, the atmospheric pressure decreases as altitude increases, as illustrated in Table 4.

A reduction in atmospheric pressure is accompanied by a decrease in the ability of humans to transfer oxygen from the lungs to the bloodstream, an effect known as hypoxia. To protect passengers and crew from hypoxia, passenger aircraft flying above 3000 metres are therefore pressurised to compensate for the reduced atmospheric pressure.

TABLE 4
Ambient Pressure at Different Altitudes

| Altitude | Altitude | Ambient Pressure | Ambient Pressure |
|---|---|---|---|
| (Feet) | (Meters) | (KPa) | (PSI) |
| 0 | 0 | 101.4 | 14.7 |
| 4750 | 1448 | 84.0 | 12.19 |
| 8000 | 2438 | 76.7 | 10.83 |
| 10000 | 3048 | 72.0 | 10.44 |
| 12000 | 3658 | 64.0 | 9.28 |
| 15000 | 4572 | 57.4 | 8.35 |
| 17500 | 5334 | 50.7 | 7.35 |
| 25000 | 7620 | 38.6 | 5.6 |
| 36000 | 10973 | 22.7 | 3.29 |
| 40000 | 12192 | 18.7 | 2.71 |
| 44000 | 13411 | 16.0 | 2.32 |
| 60000 | 18288 | 7.3 | 1.06 |

To allow an aircraft to be pressurised, the fuselage has to be strengthened so that the fuselage can act as pressure vessel. However, strengthening the fuselage has a detrimental impact on the fuel consumption and hence the potential range of the aircraft. The cabin pressure is therefore usually maintained at about 10.83 psi (74.7 kPa), which is equivalent to the atmospheric pressure at an altitude of about 2400 metres, to reduce the amount of strengthening required to the airframe.

FIGS. 7 and 8 illustrate two alternative nitrogen inserting systems that could be used on board passenger aircraft to provide an inert atmosphere in the fuel tanks of the aircrafts.

FIG. 7 illustrates a relatively simple nitrogen inserting system, which utilises the differential pressure that is naturally available when a passenger aircraft is flying at its cruising altitude, i.e. the pressure differential between the cabin pressure inside the aircraft and the atmospheric pressure outside the aircraft.

The gas separation module 40, which would include a very large number of individual intertwined hollow fibre membranes, would be located in the air conditioning system that supplies pressurised air to the passenger cabins of the aircraft. Up to 22 m³/hour of inert nitrogen rich air 46 would need to be delivered to the fuel tanks of the aircraft to replace the fuel being burned by the aircraft when it is flying at its normal cruising altitude.

Although a single gas separation module 40 is illustrated in FIG. 7, in practice a multiplicity of modules, operating together in parallel, may be needed to produce this amount of inert air 46.

The air transport regulatory authorities specify that each passenger on an aircraft should be supplied with about 10 ft³/min (0.28 m³/min) of fresh air. On large passenger aircraft, which can carry up to 550 passengers plus crew, this amount of fresh air per passenger is equivalent to a total air supply of about 165 m³/minute or 9900 m³/hour. The amount of pressurised cabin air required to produce 22 m³/hour of inert nitrogen rich air is therefore virtually insignificant compared to the total amount of fresh air supplied to the passenger cabins of an aircraft.

In the simple nitrogen inserting system illustrated in FIG. 7, the gas separation module 40 is operated by means of the differential pressure that exists between the inside and the outside of an aircraft flying at its cruising altitude, and no additional pumps are required in the system. For example, in an aircraft cruising at a height of 11000 metres the cabin pressure is 10.83 psi (74.7 kPa) whilst the atmospheric pressure outside the aircraft is 3.29 psi (26.9 kPa), and the resulting pressure differential of 7.54 psi (52.0 kPa) would be sufficient to operate the gas separation module 40.

In FIG. 7, an exit pipe 42, which takes the permeate oxygen rich air 43 from the module 40, would be connected to an outlet valve positioned in the airframe at the rear of the aircraft that would lead directly to the outside atmosphere. Passenger aircraft are already fitted with a valved outflow air system that continually discharges stale air from the passenger cabins into the outside atmosphere. The outlet valve for the reject permeate air from the gas separation module 40 could therefore be an integral part of the existing outflow air system of the aircraft.

Opening the outlet valve would create a pressure differential between the pressurised cabin air 41 being fed into the module 40, which would be at a pressure of 10.83 psi (74.7 kPa), and the atmospheric air on the outside of the aircraft, which would be at 3.29 psi (26.9 kPa). This drop in pressure would be sufficient to pull the cabin air 41 through the walls of the hollow fibre membranes and selectively enrich the air with oxygen. The low pressure outside the aircraft would then draw the reject permeate oxygen rich air 43 from module 40 into the outside atmosphere. Because the fuel tanks in an aircraft are not pressurised, the exit pipe 45 that takes the nitrogen rich air 46 from the module 40 would be connected to a valve 44, which would bleed the inert nitrogen rich air 46 into the fuel tanks at the required pressure and flow rate.

The simple nitrogen inserting system illustrated in FIG. 7 is particularly suitable for the ‘steady-state’ conditions that exist whilst an aircraft is flying at its cruising altitude, i.e. where the atmospheric pressures inside and outside the aircraft are reasonably constant. However, during a flight, different and variable pressure conditions exist when an aircraft is ascending during takeoff and descending on landing. When the aircraft is on the ground the pressure inside and outside the aircraft is of course at normal ambient ground level conditions.

On landing, the fuel tanks of the aircraft would still contain the nitrogen rich atmosphere that had been supplied by the nitrogen inserting system during the flight. However, the refuelling process on the ground is always a risky operation because a static charge could ignite aviation fuel vapour present in the filling nozzles of the fuel tanks and cause a fire. A continual supply of nitrogen rich air from the nitrogen inserting system to the filling nozzle and the headspace in the fuel tanks whilst the aircraft was being refuelled on the ground would therefore be an additional safety feature.

FIG. 8 illustrates modifications to the aircraft nitrogen inserting system that would allow the system to be used under different operating conditions. For example, the air 41 entering the gas separation module 40 would be at normal ambient atmospheric pressure, i.e. 14.7 psi (101.4 kPa), when the aircraft is on the ground and at about 10.83 psi (74.7 kPa) when the aircraft reaches its cruising altitude. To cater for differing pressure conditions the exit tube 42 that takes the permeate air 43 from the gas separation module 40 is connected to a valve 47, and at cruising altitude valve 47 allows the permeate air 43 to be passed directly to the outlet valve of the aircraft.

During ascent, descent and whilst the aircraft is on the ground, when the cabin pressure is either at or near ambient atmospheric conditions, valve 47 would divert the permeate air stream to a light vacuum pump 48. The vacuum pump would then create a pressure drop in the hollow cores of the membranes in order to facilitate the gas separation process and the reject permeate air 49 from the vacuum pump 48 would be released through the outlet valve to the outside atmosphere.

Exit tube 45 that takes the retentate nitrogen rich air from the module 40 is still connected to valve 44. At cruising altitude, valve 44 would bleed the inert nitrogen rich air 46 into the fuel tanks at the required pressure and flow rate. However, during ascent, descent and whilst the aircraft is on the ground, when the cabin pressure is either at or near ambient atmospheric conditions, valve 44 diverts the retentate air to a very light pump 50, which positively displaces the inert nitrogen rich air 51 to the fuel tanks of the aircraft.

The vacuum pumps 48 and 50 are also able to control the relative flows of the permeate air and the retentate air streams respectively. As such, the system is able to deliver the appropriate amount of inert nitrogen rich air at the required composition to suit particular operating conditions, i.e. depending on whether the aircraft was being refuelled on the ground, or if the aircraft was in takeoff, landing or cruising mode.

Compressed bleed air from an aircraft engine, which may be at a pressure of 20 to 30 psi, is used to pressurise the passenger cabins of the aircraft. A supply of compressed air is therefore available within the aircraft air conditioning system and pressurised air could be supplied to augment the pressure differential across the membranes in the air separation module. For example, instead or introducing air into the membrane module at the ambient cabin pressure of 10.83 psi during cruise mode, the air supplied to the air separation module could be further pressurised to say about 16 psi, i.e. a positive pressure of 5 psi relative to the ambient cabin pressure. The pressure at which air is allowed to enter the gas separation module may be controlled by a bleed valve. Being able to utilise a positive pressure on the outside of the membranes, in addition to the negative vacuum pressure available on the inside of the membranes, would be particularly useful when the flow of nitrogen rich air has to be rapidly increased to ensure an adequate supply of inert gas to the fuel tanks, such as when the aircraft moves from cruise mode to descent mode.

The examples described show how the nitrogen inserting system would be able to provide an inert atmosphere in the headspace of tanks or vessels containing volatile or flammable materials, such as fuels, solvents and chemicals. Because the nitrogen inserting system is a low pressure system it is safe to use and there is very little risk of a pressure blow out that could damage individual gas separation membranes, or cause damage to either the gas separation module or its immediate surroundings.

A further advantage of the inserting system is that the permeate oxygen rich air from the gas separation module is only very slightly enriched with oxygen, i. e. 22% oxygen instead of the 21% oxygen in normal air. Unlike pure oxygen or air highly enriched with oxygen, both of which can encourage spontaneous combustion, if any permeate oxygen rich air did escape from the gas separating module it would neither encourage combustion nor pose a safety risk.

As shown in the examples, the nitrogen inserting system would be particularly beneficial for fuel tanks used in transport applications, such as in vehicles, ships and aircraft. An inert atmosphere in the filling neck and the headspace of a fuel tank significantly reduces the risk of a static charge accidentally igniting fuel vapours in the mouth of the tank during refuelling. Even if the fuel vapour did ignite the inert nitrogen rich atmosphere in the filling neck of the tank would not support combustion and the flame would not be able to spread down into the fuel tank.

An inert atmosphere in the headspace of a fuel tank also reduces the risk of immediate fire or explosion in the event of a fuel tank being accidentally punctured or ruptured. By way of example, an inert atmosphere in the fuel tanks of military vehicles, ships and aircraft would help to reduce the risk of immediate fire or explosion if the fuel tank was, for example, punctured or damaged by shrapnel during battle conditions.

Bulk storage tanks for fuels, solvents and chemicals could also benefit from a nitrogen inserting system, particularly storage facilities that may be vulnerable to either man made disasters, such as potential war zones, natural disasters, such as earthquakes, or terrorist attack.

Examples of more specialised applications for a nitrogen inserting system could well include the storage of chemicals and materials that spontaneously ignite, react, oxidise, degrade or change in nature if they are stored in normal atmospheric air, as well as storage applications where a low oxygen, anti-corrosive atmosphere would be beneficial.

Although the present invention has been described with reference to the preferred embodiments, it will be understood by those skilled in the art that various changes in form and detail may be made without departing from the scope of the invention as set forth in the accompanying claims.

What is claimed is:

1. A method of separating air into a nitrogen enriched fraction and an oxygen enriched fraction using a plurality of strands of hollow fibre separation membrane wound around a core, said method comprising applying a pressure difference across said hollow fibre separation membrane, wherein said pressure difference is ≦30 psi.

2. The method as claimed in claim 1, wherein said pressure difference is selected from the group consisting of: (i) ≦25 psi; (ii) ≦20 psi; (iii) ≦15 psi; (iv) ≦10 psi; (v) ≦5 psi and (vi) ≦1 psi.

3. The method as claimed in claim 1, wherein the bores of said strands of hollow fibre membrane are maintained at a pressure which is lower than the pressure outside of said strands.

4. The method as claimed in claim 1, wherein at least some of said pressure difference is created by withdrawing air from the bores of said strands of hollow fibre separation membrane.

5. The method as claimed in claim 4, wherein the amount of pressure difference across said hollow fibre separation membrane caused by withdrawing air from the bores is selected from the group consisting of: i) 10-15 psi; (ii) 5-10 psi; (iii) ≦5 psi; and (iv) ≦1 psi.

6. The method as claimed in claim 1, comprising supplying pressurised air to the outer surfaces of said strands of hollow fibre separation membrane to cause at least a portion of the pressure difference across said hollow fibre separation membrane.

7. The method as claimed in claim 6, wherein the amount of pressure difference across said hollow fibre separation membrane caused by supplying pressurised air to the membrane is selected from the group consisting of: i) 10-15 psi; (ii) 5-10 psi; (iii) ≦5 psi; and (iv) ≦1 psi.

8. The method as claimed in claim 1, comprising withdrawing permeate oxygen enriched air from the bores of said strands of hollow fibre membrane at a first rate; and withdrawing retentate nitrogen enriched air from around said strands of hollow fibre membrane at a second, lower, rate.

9. The method as claimed in claim 1, wherein said hollow fibre membrane is a composite material comprising a porous hollow fibre tube coated with a selective polymer.

10. The method as claimed in claim 9, wherein the external surface of the porous hollow fibre tube has been subjected to a modification technique so as to increase the number of pores in said external surface before it is coated with said selective polymer.

11. The method as claimed in claim 10, wherein the porous hollow fibre tube is manufactured from polyethersulfone polymer material.

12. The method as claimed in claim 11, wherein the structure of the polyethersulfone fibre tube is modified by soaking said fibre tube in a solvent solution comprising acetone until the solution has penetrated into the pores of said fibre tube, displacing the solution from the pores with distilled water and then drying the fibre tube.

13. The method as claimed in claim 10, wherein the application of the modification technique to the fibre tube results in the fibre tube having up to twice as many pores in its structure than an unmodified fibre tube and a gas permeability up to twice that of the unmodified fibre tube.

14. The method as claimed in claim 10, wherein the application of the modification technique to the fibre tube improves the surface characteristics of the fibre tube so that the outer surface of the fibre tube is able to support a very thin, uniform, defect free layer of selective polymer material.

15. The method as claimed in claim 9, wherein the selective polymer comprises polydimethylsiloxane.

16. The method as claimed in claim 9, wherein the selective polymer coating has been subjected to a plasma treatment technique.

17. The method as claimed in claim 16, wherein the plasma treatment technique consists of placing the coated hollow fibre tubes between two electrodes in a chamber containing a plasma forming gas, such as nitrogen, oxygen, argon, helium or carbon dioxide, or mixtures thereof, applying a voltage difference between the electrodes to produce a high-frequency plasma discharge and subjecting the coated tubes to the plasma discharge.

18. The method as claimed in claim 1, comprising providing said strands of gas separation membrane in a gas separation module, wherein the rate of production and/or composition of the nitrogen enriched air is varied by controlling the pressure and/or flow rate of the nitrogen enriched air stream leaving said gas separation module.

19. The method as claimed in claim 18, wherein a vacuum pump or bleed valve controls said pressure and/or flow rate of the nitrogen enriched air stream.

20. The method as claimed in claim 1, comprising providing said strands of gas separation membrane in a gas separation module, wherein the rate of production and/or composition of the nitrogen enriched air is varied by controlling the pressure and/or flow rate of the oxygen enriched air stream leaving said gas separation module.

21. The method as claimed in claim 20, wherein a vacuum pump or bleed valve controls said pressure and/or flow rate of the oxygen enriched air stream.

22. The method as claimed in claim 1, comprising providing said strands of gas separation membrane in a gas separation module, wherein the rate of production and/or composition of the nitrogen enriched air is varied by controlling the pressure at which air is supplied into said gas separation module.

23. The method as claimed in claim 22, wherein a pump or bleed valve controls the pressure at which air is supplied into said gas separation module.

24. The method as claimed in claim 1, wherein said nitrogen enriched air comprises between 10% oxygen, 90% nitrogen and 12% oxygen, 88% nitrogen.

25. The method as climed in claim 1, wherein said nitrogen enriched air comprises less than 10% oxygen.

26. The method as claimed in claim 1, wherein said nitrogen enriched air comprises 7% oxygen and 93% nitrogen.

27. The method of supplying nitrogen enriched air to a fuel tank comprising a method as claimed in claim 1.

28. A gas separation module for separating air into a nitrogen enriched fraction and an oxygen enriched fraction, said module comprising a plurality of strands of hollow fibre separation membrane wound around a core, wherein said hollow fibre separation membrane is configured to separate air into nitrogen and oxygen enriched fractions when a pressure difference of ≦30 psi is applied across said membrane.

29. The module as claimed in claim 28, wherein said hollow fibre separation membrane is a composite material comprising a porous hollow fibre tube coated with a selective polymer.

30. The method as claimed in claim 29, wherein the external surface of the porous hollow fibre tube has been subjected to a modification technique so as to increase the number of pores in said external surface before it is coated with said selective polymer.

31. A gas separation module for separating air into a nitrogen enriched fraction and an oxygen enriched fraction, said module comprising a plurality of strands of composite hollow fibre separation membrane wound around a core, wherein said membrane comprises a porous hollow fibre tube coated with a selective polymer, and wherein the external surface of said porous fibre tube has been subjected to a modification technique so as to increase the number of pores in said external surface before it has been coated with said selective polymer.

32. The module as claimed in claim 31, wherein said hollow fibre separation membrane is configured to separate air into nitrogen and oxygen enriched fractions when a pressure difference of ≦30 psi is applied across said membrane.

33. The module as claimed in claim 28, wherein said pressure difference is selected from the group consisting of: (i) ≦25 psi; (ii) ≦20 psi; (iii) ≦15 psi; (iv) ≦10 psi; (v) ≦5 psi and (vi) ≦1 psi.

34. The module as claimed in claim 29, wherein the porous hollow fibre tube is manufactured from polyethersulfone polymer material.

35. The module as claimed in claim 34, wherein the structure of the polyethersulfone fibre tube has been modified by soaking said fibre tube in a solvent solution comprising acetone until the solution has penetrated into the pores of said fibre tube, displacing the solution from the pores with distilled water and then drying the fibre tube.

36. The module as claimed in claim 30, wherein the application of the modification technique to the fibre tube has resulted in the fibre tube having up to twice as many pores in its structure as an unmodified fibre tube and a gas permeability up to twice that of the unmodified fibre tube.

37. The module as claimed in claim 30, wherein the application of the modification technique to the fibre tube has improved the surface characteristics of the fibre tube so that the outer surface of the fibre tube is able to support a very thin, uniform, defect free layer of selective polymer material.

38. The module as claimed in claim 29, wherein the selective polymer comprises polydimethylsiloxane.

39. The module as claimed in claim 29, wherein the selective polymer coating has been subjected to a plasma treatment technique.

40. The module as claimed in claim 39, wherein the plasma treatment technique consists of placing coated hollow fibre tubes between two electrodes in a chamber containing a plasma forming gas, such as nitrogen, oxygen, argon, helium or carbon dioxide, or mixtures thereof, applying a voltage difference between the electrodes to produce a high-frequency plasma discharge and subjecting the coated tubes to the plasma discharge.

41. The module as claimed in claim 28, wherein the module is manufactured from lightweight, pressure resistant materials, such as plastics, lightweight metals or combinations of plastic and metal materials.

42. An air separation system comprising an air separation module as claimed in claim 28, said system further comprising means to supply air to the module, means to allow oxygen enriched air to exit the module from one side of the membrane, and means to allow nitrogen enriched air to exit the module from another side of the membrane.

43. The system as claimed in claim 42, comprising means for varying the pressure and/or flow rate of the nitrogen enriched air stream leaving the gas separation module to vary the rate of production and/or composition of the nitrogen enriched air.

44. The system as claimed in claim 43, wherein a vacuum pump or bleed valve controls the pressure and/or flow rate of the nitrogen enriched air leaving the gas separation module.

45. The system as claimed in claim 42, comprising means for varying the pressure and/or flow rate of the oxygen enriched air stream leaving the gas separation module to vary the rate of production and/or composition of the nitrogen enriched air.

46. The system as claimed in claim 45, wherein a vacuum pump or bleed valve controls the pressure and/or flow rate of the oxygen enriched air stream leaving the gas separation module.

47. The system as claimed in claim 42, comprising means for varying the pressure at which air is supplied into the gas separation module to vary the rate of production and/or composition of the nitrogen enriched air leaving the module.

48. The system as claimed in claim 47, wherein a positive pressure pump or bleed valve controls the pressure at which air is supplied into the gas separation module.

49. The fuel system comprising a fuel tank and a system as claimed in claim 42 for supplying nitrogen enriched air to the fuel tank.

50. An atmosphere inserting system comprising a system as claimed in claim 42 in fluid communication with a space requiring an inert atmosphere.

51. A gas separation module comprising:
a plurality of strands of hollow fibre separation membrane;
means for releasing at a first rate permeate oxygen enriched air from the hollow cores of said strands of membrane to the outside of said module; and
means for releasing retentate nitrogen enriched air from the module at a second rate;
wherein said first rate is greater than said second rate.
